(19) United States
(12) Patent Application Publication
(10) Pub. No.: US 2021/0177010 A1
(43) Pub. Date: Jun. 17, 2021

(54) PET FOOD, GRANULAR PET FOOD, AND METHOD FOR PRODUCING PET FOOD

(71) Applicant: Unicharm Corporation, Ehime (JP)

(72) Inventors: Thi Yen Minh Nguyen, Itami-shi (JP); Munehiro Usui, Itami-shi (JP); Waka Sawada, Itami-shi (JP); Masaki Shiota, Itami-shi (JP); Tadatoshi Nobata, Itami-shi (JP)

(73) Assignee: Unicharm Corporation, Ehime (JP)

(21) Appl. No.: 17/055,291

(22) PCT Filed: Jun. 25, 2018
(86) PCT No.: PCT/JP2018/024189

§ 371 Date: Nov. 13, 2020

(30) Foreign Application Priority Data
May 18, 2018 (JP) 2018-096468

(51) Int. Cl. A23K 20/158; A23K 40/30; A23K 50/40; A23K 20/147

(52) U.S. Cl. CPC A23K 20/158; A23K 20/147; A23K 50/40; A23K 40/30

(57) ABSTRACT

A pet food is provided, including a base substance and a coating part that coats a part of the base substance, in which a part of the base substance is exposed and a component composition of the base substance and a component composition of the coating part are different from each other.

### TECHNICAL FIELD

The present invention relates to a pet food, a granular pet food, and a method for producing the pet food.

Priority is claimed on Japanese Patent Application No. 2018-96468, filed on May 18, 2018, the content of which is incorporated herein by reference.

### BACKGROUND ART

In a pet food, various ideas have been proposed so that pets can enjoy eating, that is, palatability improves.

For example, Patent Literature 1 discloses an animal food including a shell component of a cereal base and a soft internal component including a lipid component, in which palatability is improved by making the animal food into a double structure in which the soft internal component is completely surrounded by the shell component.

### CITATION LIST

### Patent Literature

[Patent Literature 1]

Japanese Patent No. 4689932

### SUMMARY OF INVENTION

### Technical Problem

However, in the animal food described in Patent Literature 1, since the soft internal component is completely surrounded by the shell component, in view of appearance, it is poor in visual change and visual interest cannot be increased. In addition, the food texture at the beginning of chewing is uniform and a change depending on the food texture is poor.

Thus, an object of the present invention is to provide a pet food and a granular pet food having improved palatability by a visual change and changes in texture and taste, and a method for producing the pet food.

### Solution to Problem

The present invention includes the following aspects.

(1) A pet food including a base substance and a coating part that coats a part of the base substance, in which a part of the base substance is exposed and a component composition of the base substance and a component composition of the coating part are different from each other.

(2) The pet food according to (1), in which a color of the base substance and a color of the coating part are different from each other.

(3) The pet food according to (2), in which the pet food satisfies at least one condition selected from the group consisting of the following (a) to (d) in a CILAB color space.

(a) ΔL* (L* of coating part−L* of base substance) is 5.0 or more.

(b) ΔE* (color difference between coating part and base substance) is 5.0 or more.

(c) ΔC (C* of coating part−C* of base substance) is −7.5 to −1.0.

(d) ΔC* (C* of coating part−C* of base substance) is 1.0 to 7.5.(4) The pet food according to any one of (1) to (3), in which a taste of the base substance and a taste of the coating part are different from each other.

(5) The pet food according to any one of (1) to (4), in which a breaking force of the base substance and a breaking force of the coating part are different from each other.

(6) The pet food according to (5), in which the breaking force of the coating part is weaker than the breaking force of the base substance.

(7) The pet food according to any one of (1) to (6), in which the base substance has at least one recessed part.

(8) The pet food according to any one of (1) to (7), in which the coating part contains oil and fat and a powder ingredient.

(9) The pet food according to any one of (1) to (8), in which an area proportion of the coating part to a surface area of an entirety of the pet food is 5% to 50%.

(10) The pet food according to any one of (1) to (9), including a surface having the coating part; and a surface formed by only an exposed portion where the base substance is exposed.

(11) The pet food according to any one of (1) to (10), in which a height from a surface of the base substance to a topmost part of the coating part is 0.1 to 2 mm.

(12) The pet food according to any one of (1) to (11), in which the base substance has a granular shape.

(13) The pet food according to (12), in which the base substance is a puffed granule.

(14) A granular pet food comprising: a plurality of pet food granules, in which the plurality of pet food granules include a plurality of the pet foods according to claim 12 or 13, and an area proportion of the coating parts to a surface area of an entirety of the plurality of pet food grains k 5% to 50%.

(15) A method for producing a pet food including a base substance, and a coating part that coats a part of the base substance, in which the part of the base substance is exposed, and a component composition of the base substance and a component composition of the coating part are different from each other, the method including: a coating step of coating the part of the base substance with a coating part-forming composition having a composition different from a composition of the base substance; and a solidifying step of solidifying the coating part-forming composition.

The present invention also includes the following aspects.

(16) The method for producing a pet food according to (15), in which a color of the base substance and a color of the coating part are different from each other.

(17) The method for producing a pet food according to (16), in which the pet food satisfies at least one condition selected from the group consisting of the following (a) to (d) in a CILAB color space.

(a) ΔL* (L* of coating part−L* of base substance) is 5.0 or more.

(b) ΔE* (color difference between coating part and base substance) is 5.0 or more.

(c) ΔC* (C* of coating part−of base substance) is −7.5 to −1.0.

(d) ΔC* (C* of coating part−C* of base substance) is 1.0 to 7.5.(18) The method for producing a pet food according to (15) or (16), in which a taste of the base substance and a taste of the coating part are different from each other.

(19) The method for producing a pet food according to any one of (15) to (18), in which a breaking force of the base substance and a breaking force of the coating part are different from each other.

(20) The method for producing a pet food according to (19), in which the breaking force of the coating part is weaker than the breaking force of the base substance.

(21) The method for producing a pet food according to any one of (15) to (20), in which the base substance has at least one recessed part.

(22) The method for producing a pet food according to any one of (15) to (21), in which the coating part contains oil and fat and a powder ingredient.

(23) The method for producing a pet food according to any one of (15) to (22), in which an area proportion of the coating part to a surface area of an entirety of the pet food is 5% to 50%.

(24) The method for producing a pet food according to any one of (15) to (23), including a surface having the coating part; and a surface formed by only an exposed portion where the base substance is exposed.

(25) The method for producing a pet food according to any one of (15) to (24), in which a height from a surface of the base substance to a topmost part of the coating part is 0.1 to 2 mm.

(26) The method for producing a pet food according to any one of (15) to (25), in which the base substance has a granular shape.

(27) The method for producing a pet food according to (26), in which the base substance is a puffed granule.

### Advantageous Effects of Invention

According to the present invention, a pet food and a granular pet food having improved palatability by a visual change and changes in texture and taste, and a method for producing the pet food are provided.

### BRIEF DESCRIPTION OF DRAWINGS

FIG. 1A shows an example of a pet food according to a first embodiment of the present invention.

FIG. 1B shows an example of the pet food according to the first embodiment of the present invention.

FIG. 2 shows an example of a granular pet food according to a second embodiment of the present invention.

FIG. 3 shows a base substance used in an example of the present invention.

### DESCRIPTION OF EMBODIMENTS

In the present specification, the term “pets” indicates animals that have been bred by people. In a narrower sense, pets are animals being cared for by their owners. Further, the term “pet food” indicates feed for pets. The pet food of the present invention can be sold as “animal feed” or “animal food”.

[Breaking (Hardness) Measurement Method]

In the present specification, a breaking force (breaking hardness) of a pet food is indicated by a value obtained by the following measurement method.

A breaking force when the pet food is compressed at a constant compression speed is measured under the following conditions, using a compression tester (texture analyzer, model number: EZ-SX, manufactured by Shimadzu Corporation).

Plunger: cylindrical plunger with a diameter of 15 mm and a thickness of 5 mm, platform: saucer deeply dug in an asterisk shape (an inner diameter about 33 mm×a depth about 4 mm), compression speed: 60 mm/min, lowest point of the plunger: 4 mm (compression distance), and a measurement temperature: 25° C.

Specifically, one pet food to be measured is placed on the saucer, and a test force is measured while vertically pressing the plunger from directly above at a constant speed. A peak value (maximum value) of the test force is read as the breaking force value. The measurement is repeated for 10 pieces to obtain an average value. In a case where the pet food breaks during the measurement, the measurement of the pet food is finished at that time.

The breaking force (unit: kgw) measured by the compression tester is multiplied by 9.8 so that a unit thereof is converted to Newton (N).

[Color Measurement]

In the present specification, a color of each of the base substance and the coating part of pet food is indicated by a value obtained by the following measurement method.

The colors of the base substance and the coating part are measured using a colorimetric color difference system ZE6000 (manufactured by Nippon Denshoku Industries Co., Ltd.).

The base substance is uniformly pulverized using a Millser (manufactured by Iwatani Corporation) to obtain a measurement sample.

The coating part is heated to 70° C. so as to dissolve a coating part composition, then poured in a measurement container, allowed to stand at normal temperature for 1 hour to solidify and obtain a measurement sample.

A measurement sample is put in the amount of about 80% into a measurement container with a capacity of 10 and each coordinate value in the CIELAB color space is measured at three points according to the manual included with the device. Each data is obtained by the following formula.

ΔL*: Coating part (L*)−Base substance (L*)

Δa*: Coating part (a*)−Base substance (a*)

Δb*: Coating part (b*)−Base substance (b*)

ΔE*: {(ΔL*)²+(Δa*)²+(Δb*)²}^{1/2}

C*={(a*)²+(b*)²}^{1/2}

ΔC*: Coating part (C*)−Base substance (C*)

[Measurement of Area Proportion of Coating Part]

in the present specification, the area proportion of the coating part of the pet food is indicated by a value obtained by the following measurement method (1) or (2).

<<Measurement Method (1)>>

The area proportion of the coating part is measured by image analysis using a visual analyzer.

Specifically, the pet food (in a case of the granular pet food, a predetermined amount (for example, about 50 g) of the pet food granules) is placed in a measurement area on a plane (in a case of the granular pet food, scattered randomly irrespective of front and back) and color composition analysis data about a surface part is acquired. From the data obtained by analyzing the composition of each color for the entirety, a color having a color difference (ΔE*) of 13.0 or less with respect to a central color of the coating part is analyzed as the color of the coating part, and the area proportion of the coating part with respect to the entire pet food is calculated as a percentage.

<<Measurement Method (2)>>

The pet food is observed and photographed with an optical microscope (VHX-900F (manufactured by KEYENCE)), and the area proportion of the coating part is measured.

Specifically, the pet food (in the case of granular pet food, one pet food granule) is observed by an optical microscope, and an image of a surface having the coating part is acquired. Based on the image, a surface area of the entire pet food and an area of the coating part are measured, and the area proportion of the coating part to the entire pet food is calculated as a percentage.

[Method of Measuring Major Axis, Minor Axis, and Thickness of Pet Food Granule]

In the present specification, regarding an average major axis of the pet food granule, in a case where the pet food granule placed on a horizontal table is viewed from above, major axes and minor axes thereof are measured with a caliper, and average values thereof are taken as the average major axis and an average minor axis. In addition, regarding a thickness of the pet food granule, a thickness from a lower surface (lower end) to an upper surface (upper end) of the pet food granule placed on a horizontal table is measured.

<Pet Food>

The pet food according to a first embodiment of the present invention is a pet food including the base substance and the coating part that coats a part of the base substance, in which a part of the base substance is exposed and a component composition of the base substance and a component composition of the coating part are different from each other.

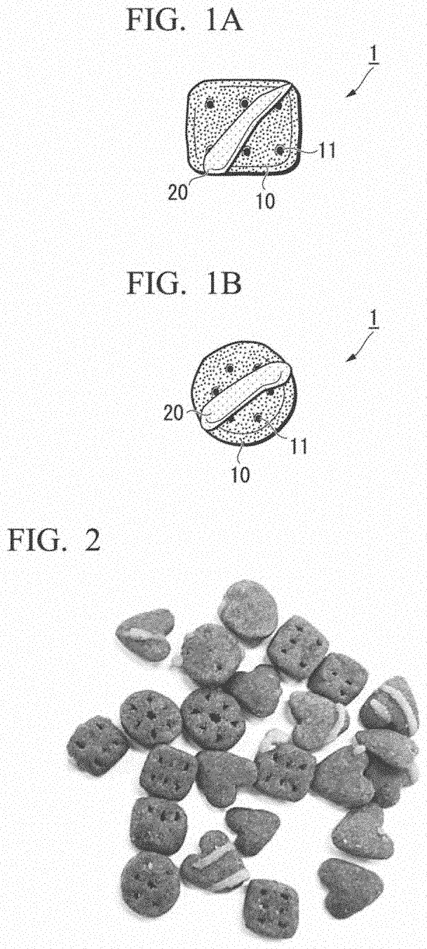

FIGS. 1A and 1B are views showing an example of the pet food according to the present embodiment. In FIG. 1A, a part of a base substance 10 having a square shape is coated with a coating part 20. In FIG. 1B, a part of the base substance 10 having a round shape is coated with the coating part 20. Each of the base substances 10 of FIGS. 1A and 1B has a recessed part 11.

<<Base Substance>>

The shape of the base substance is not particularly limited, and any shape such as a granular shape, a rod shape, a plate shape, a spherical shape, a tubular shape, a cylindrical shape, and a conical shape can be adopted. Examples of a sectional shape of the base substance include a circle, an ellipse, a polygon (such as a triangle, a quadrangle, a pentagon, a hexagon, a rhombus, and a trapezoid), a star shape, and a heart shape, but are not limited thereto. In a case where the base substance is granular, examples of the shape of the granule include a circle, an ellipse, a quadrangle, a heart shape, a star shape, a cross shape, a donut shape, and a clover shape, but are not limited thereto.

The size of the base substance is not particularly limited as long as the pet can easily eat. For example, in a case where the pet food is granular, as the size of the pet food granule, for example, both the major axis and the minor axis are preferably within the range of 3 to 30 mm, more preferably 6 to 16.5 mm, and still more preferably 8 to 12 mm. The thickness of the pet food granule is preferably, for example, 2 to 8 mm, and more preferably 3 to 6 mm.

In addition, the base substance may have at least one recessed part. The disposition, the shape, and the number of recessed parts are not particularly limited, and any disposition, any shape, and any number can be adopted. When the base substance has the recessed part, the coating part is prevented from being peeled off. The recessed part may be a through-hole or a non-through-hole. Examples of the shape of the recessed part include a circle, an ellipse, a polygon (such as a triangle, a quadrangle, a pentagon, a hexagon, a rhombus, and a trapezoid), and a groove shape. The number of recessed parts is, for example, 1 to 10, 2 to 8, or 4 to 6. In a case where there are a plurality of recessed parts, an example of the disposition thereof includes a lattice shape, a grid shape, a radial shape, and a circular shape.

For the base substance, known ingredients of pet food can be appropriately used. The base substance can be obtained, for example, by heating and forming a mixture of the ingredients, obtained by mixing the powder ingredient and the liquid ingredients. The base substance may be a puffed granule or a non-puffed granule, and is preferably the puffed granule from the viewpoint of food texture. The term “puffed granule” indicates a granule obtained by forming a mixture of the ingredients into a granular shape and also indicates a granule obtained by performing a puffing step of foaming inside the mixture of the ingredients. The term “puffing step” indicates a step of generating a gas in the mixture of the ingredients using a technique of carrying out heating, fermentation, a chemical reaction, or pressure reduction. In the puffing step, as a gas is generated, the volume of the mixture of the ingredients is increased so as to have porous properties. Further, as the volume of the mixture of the ingredients is increased, the bulk density thereof is decreased. Before or after the puffing step, or at the same time as the puffing step, the “puffed granule” is obtained by forming the mixture of the ingredients in a granular shape. The “non-puffed granule” indicates a granule produced without performing the puffing step.

Examples of the powder ingredient include, as a main ingredient, a powder of cereals (such as corn, wheat, rice, corn gluten meal, wheat bran, bread crumbs, barley, buckwheat, and rye), potatoes (such as sweet potatoes and potatoes), beans (such as round soybeans and defatted soybeans), starches (such as wheat starch, corn starch, rice starch, potato starch, tapioca starch, sweet potato starch, sago starch, and modified starch), meats (livestock such as chicken, beef, pork, and venison; liver, beef muscle, pork ears, chicken fillet, and the like, which represent part thereof; chicken meal, pork meal, beef meal, mixed meal of these, meat extract, and the like, which are processed product thereof), seafoods (such as fish such as tuna, bonito and horse mackerel; crustaceans such as shrimp and crab; molluscs such as octopus and squid; shellfish such as scallops and turban shells; fish meal, fish extract, Katsuobushi, and the like, which are processed product thereof; and small fish whitebait, and the like, which represent a form thereof; a white fish and the like, which represents a quality thereof; and tuna Chiai and the like, which represent a part thereof), vegetables, seeds, mushrooms, fruits, algae, eggs, sugars, milks, and others (herbs, yeast, cellulose, and the like), and, as additives, vitamins, inorganic salts, amino acids, acidulants, seasonings, flavors, coloring agents, preservatives, emulsifiers, and antioxidants.

Examples of the liquid ingredients include water, oils and fats, sugars (such as liquid sugar), humectants, preservatives, and emulsifiers. The humectant and the emulsifier may be added in a state of aqueous solution.

The oil and fat may be vegetable oil and fat or animal oil and fat. It is preferable to use animal oil and fat from the viewpoint that high palatability is easily obtained. Preferred examples of the animal oil and fat include chicken oil, hog fat (lard), beef tallow (vet), and milk fat.

As a mixing example of the base substance, a total of 20% to 70% by mass of cereals, a total of 10% to 50% by mass of meat, a total of 0% to 30% by mass of seafood, a total of 0% to 10% by mass of vitamins, minerals, and amino acids, 0% to 15% by mass of cellulose powder, and 1% to 20% by mass of animal oil and fat may be used.

<<Coating Part>>

The coating part coats a part of the base substance and has a component composition different from that of the base substance.

The coating part does not coat the entire base substance, and a part of the base substance is exposed. When including the coating part having a component composition different from that of the base substance, a visual change, a texture change, and a taste change are imparted to the pet food.

The area proportion of the coating part to the surface area of the entire pet food is not particularly limited, and is, for example, 5% to 50%, preferably 5% to 30%, and more preferably 5 to 25%. More specifically, in a case where the method described in “[Measurement of area proportion of coating part] or <<Measurement method 1>>” is used, the area proportion of the coating part to the surface area of the entire pet food is, for example, 5% to 50%, preferably 5% to 30%, more preferably 5% to 25%, and further preferably 7% to 15%. In addition, in a case where the method described in “[Measurement of area proportion of coating part] or (Measurement method 2)” is used, the area proportion of the coating part to the surface area of the entire pet food is, for example, 5% to 50%, preferably 5% to 40%, more preferably 8% to 30%, and further preferably 10% to 25%. In the case of granular pet food, the area proportion of the coating part of a plurality (for example, about 2 to 10) of pet food granules is calculated using the method described in “[Measurement of area proportion of coating part] or <<Measurement method 2>>, and an average thereof may be obtained as the area proportion of the coating part.

Further, the pet food according to the present embodiment may include a surface having the coating part and a surface formed by only an exposed portion where the base substance is exposed. In this case, when the surface having the coating part and the surface formed by only the exposed portion are sandwiched between the teeth of the pet, in the surface having the coating part, the teeth enter the coating part first, and then enter the base substance. Therefore, it is possible to impart a different texture depending on a chewing depth. That is, it is possible to provide a pet food having different textures depending on a region in a depth direction of chewing (beginning of chewing to end of chewing).

A height of the coating part is not particularly limited. The height from the surface of the base substance to the topmost part of the coating part is, for example, 0.1 to 2 mm, and preferably 0.5 to 2 mm. By setting the height of the coating part to be equal to or higher than the lower limit value of the range, the texture of the coating part can be provided at the beginning of chewing. Also, by setting the height of the coating part to be equal to or lower than the upper limit value of the range, peeling of the coating part is suppressed.

The shape of the coating part is not particularly limited, and is preferably a line shape from the viewpoint of production efficiency. For example, in a case where the pet food is granular, the coating part may be formed so as to cross or longitudinally cross the pet food granule. The shape of the coating part is not limited to the line shape, and may be a dot shape, a circular shape, a polygonal shape, or the like.

The color of the coating part is preferably different from the color of the base substance. As a result, a change in appearance is imparted to the pet food, which can be interesting to pets. It is preferable that the difference in colors between the coating part and the base substance be to a degree recognizable by pets. For example, it is preferable to satisfy at least one condition selected from the group consisting of the following (a) to (d) in the CRAB color space.

(a) ΔL* (L* of coating part−L* of base substance) is 5.0 or more.

(b) ΔE* (color difference between coating part and base substance) is 5.0 or more.

(c) ΔC* (C* of coating part−C* of base substance) is −7.5 to −1.0.

(d) ΔC* (C* of coating part−C* of base substance) is 1.0 to 7.5.

The colors of the coating part and the base substance more preferably satisfy two or more of (a), (b), and (c) or (d), and further preferably satisfy three of (a) to (c), or three of (a), (b), and (d). The ΔL* is preferably 7 or more, more preferably 8 or more, and further preferably 9 or more. The range of ΔL* is, for example, 5 to 15, preferably 7 to 13, more preferably 8 to 12, and further preferably 9 to 11. The ΔE* is preferably 7 or more, more preferably 8 or more, and further preferably 9 or more.

The range of ΔE* is, for example, 5 to 18, preferably 7 to 15, more preferably 8 to 13, and further preferably 9 to 12. The ΔC* is, for example, preferably −7.0 to −1.5, more preferably −6.0 to −2.0, and further preferably −5.0 to −3.0. Alternatively, the ΔC* is, for example, preferably 1.5 to 7.0, more preferably 2.0 to 6.0, and further preferably 3.0 to 5.0. When the ΔC* is in the range of −7.5 to −1.0, the coating part is visually recognized as a paler color than that of the base substance. When the ΔC* is in the range of 1.0 to 7.5, the coating part is visually recognized as a lighter color than that of the base substance.

The breaking force (hardness) of the coating part is preferably different from the breaking force of the base substance. Accordingly, a change in texture of the pet food is imparted. The breaking force of the coating part is preferably lower than the breaking force of the base substance. As a result, in a case where the coating part of the pet food is chewed, the teeth easily enter the coating part and a soft texture is felt, and in a case where an exposed portion of the base substance of the pet food is chewed, a hard texture is felt.

That is, it is possible to provide a pet food having different textures depending on a region in a plane direction of chewing. Also, when the chewing depth is shallow (such as beginning of chewing), the texture is soft and the teeth easily enter the granule, and when chewing deeply, a hard texture can be felt. That is, it is possible to provide a pet food having different textures depending on a region in a depth direction of chewing (beginning of chewing to end of chewing).

A taste of the coating part is preferably different from a taste of the base substance. Accordingly, a change in the taste of the pet food is imparted. That is, it is possible to provide a pet food having different tastes depending on a region in a plane direction of chewing. It is possible to provide a pet food having different tastes depending on a region in a depth direction of chewing (beginning of chewing to end of chewing).

The coating part may have a component composition different from that of the base substance, and a known ingredient for a pet food can be appropriately used. The coating part may contain, for example, oil and fat and a powder ingredient. Examples of the composition for forming the coating part include a creamy composition. For example, oil and fat, a powder ingredient, and an optional ingredient such as an appropriate excipient may be mixed and stirred at about 40° C. to 60° C. to obtain a creamy composition, which may be used as a coating part-forming composition. The coating part can be formed, for example, by coating a part of the base substance with the creamy composition, cooling and solidifying.

The oil and fat may be vegetable oil and fat or animal oil and fat. Also, hardened oil and fat may be used.

As the oil and fat, for example, those having a high melting point (approximately 45° C. to 65° C. and preferably approximately 56.5° C. to 60.5° C.) and those having a low melting point (approximately 20° C. to 45° C. and preferably approximately 30° C. to 40° C.) are preferably used in combination. In a case where only those having the high melting point are used, it is difficult to dissolve or decompose the oil and fat in the body when ingested. On the other hand, when only those having the low melting point are used, there are concerns that processability is poor and the oil and fat will melt when the temperature is high. When those having the high melting point and those having the low melting point are used in combination, it is possible to obtain a composition that has good processability and is easily dissolved when eaten. Examples of such a combination include a combination of vegetable oil and fat and hardened oil and fat. Alternatively, refined beef tallow, refined pork tallow, chicken tallow, sheep tallow, horse tallow, palm fractionated oil, palm kernel oil, vegetable oil and fat, fish oil, fatty acids (such as linoleic acid and linolenic acid), butter, and the like may be used instead of the vegetable oil and fat or together with the vegetable oil and fat. Preferred examples of the vegetable oil and fat include palm oil. The hardened oil and fat may be vegetable or animal. The hardened oil and fat is preferably an extremely hardened oil and fat (melting point of 56.5° C. to 60.5° C.).

The powder ingredient is blended to lower the fluidity of the creamy composition to forum a raised coating part. As examples of the powder ingredient, all powder ingredients usable for a pet food can be used without any particular limitation. For example, those exemplified in “<<Base substance>>” above are mentioned. Specific examples thereof include cereals, meat, starches, rice bran, sugars, beans, seafood, eggs, milk, plant protein extracts, fruits, mushrooms, algae, vitamins, minerals, amino acids, cellulose, yeast, flavors, and seasonings.

Preferred examples of the powder ingredient include soybean powder. Among these, concentrated soy protein is preferable, and those obtained by being heat treated in consideration of digestion are more preferable. In addition, pregelatinized wheat flour, separated soy protein, protein hydrolyzate, brewer's yeast powder, cheese powder, milk powder, seafood powder, amino acid powder, meat, beans, rice flour, malt powder, nucleic acid, and the like may be used instead of the soybean powder or together with the soybean powder. It is preferable to use a powder ingredient that is compatible with the oil and fat. The pulverized particle size of the powder ingredient is not particularly limited, but the maximum pulverized particle size is preferably 400 μm or smaller, and the average pulverized particle size is more preferably 100 μm or smaller.

In addition to the above, a freeze-dried ingredient may be used as the ingredient of the coating part-forming composition, from the viewpoint of improving the appearance or palatability. The freeze-dried ingredient may be sprinkled onto the creamy composition, for example, after coating the base substance with the creamy composition and before solidifying.

As a mixing example of the coating part-forming composition, a total of 5% to 70% by mass of oil and fat having the low melting point (such as vegetable oil and fat), a total of 3% to 40% by mass of oil and fat having the high melting point (such as the extremely hardened oil and fat), a total of 5% to 70% by mass of powder ingredients, and a total of 2.5% to 35% by mass of excipients (such as dextrin, starches, monosaccharides, and oligosaccharides) may be used.

A ratio of the mass of the coating part to the total mass of the entire pet food is not particularly limited, and is, for example, 1% to 20% by mass, preferably 3% to 15% by mass, and more preferably 5% to 12% by mass.

The pet food according to the present embodiment can be suitably used as, for example, a pet food for cats. Since the pet food according to the present embodiment includes the coating part that coats a part of the base substance and the exposed portion where the base substance is exposed, there is a change in appearance, and a different texture or taste depending on the chewing position or the chewing depth is provided. Due to these changes in appearance, texture, and taste, a pet food with improved palatability is provided.

<Granular Pet Food>

A granular pet food according to a second embodiment of the present invention includes a plurality of pet food granules, in which the plurality of pet food granules include a plurality of the pet foods according to the first embodiment, and an area proportion of the coating parts to a surface area of an entirety of the plurality of the pet food granules is 5% to 30%.

In the present specification, the “granular pet food” refers to a pet food including the plurality of pet food granules. The granular pet food according to the present embodiment includes a plurality of granular pet foods among the pet food according to the first embodiment. That is, at least some of the pet food granules forming the granular pet food according to the present embodiment are pet food granules each having the coating part that coats a part of the base substance.

Among the pet food granules forming the granular pet food, a proportion of the pet food granules each having the coating part is not particularly limited, and is, for example, 20% or more, preferably 30% or more, more preferably 50% or more, and further preferably 60%. An upper limit of the proportion of those each having the coating part is not particularly limited, and the proportion of those each having the coating part may be 100%.

The granular pet food according to the present embodiment can include a pet food granule (only the base substance) having no coating part, except for those each having the coating part.

In the granular pet food according to the present embodiment, the area proportion of the coating parts to a surface area of the entirety of the pet food granule forming the granular pet food is 5% to 50%. The area proportion of the coating part can be measured by the method described in “[Measurement of area proportion of coating part] <<Measurement method 1>>”, using some or all of the pet food granules forming the granular pet food. The amount of the pet food granules to be used for the measurement is, for example, a predetermined amount of 50 g. The area proportion of the coating part to the surface area of the entirety of the pet food granules forming the granular pet food is preferably 5% to 30%, more preferably 5% to 25%, and further preferably 7% to 15%.

The ratio of the total mass of the coating part to the total mass of the entire granular pet food is not particularly limited, and is, for example, 1% to 20% by mass, preferably 3% to 15% by mass, and more preferably 5% to 12% by mass.

An example of the granular pet food according to the present embodiment is shown in FIG. 2.

<Method for Producing Pet Food>

A method for producing a pet food according to a third embodiment of the present invention is a method for producing the pet food including the base substance, and the coating part that coats a part of the base substance, in which a part of the base substance is exposed, and a component composition of the base substance and a component composition of the coating part are different from each other. The method for producing the pet food includes a coating step of coating the part of the base substance with a coating part-forming composition having a composition different from a composition of the base substance; and a solidifying step of solidifying the coating part-forming composition.

According to the method for producing a pet food of the present embodiment, it is possible to produce the pet food according to the first embodiment and the granular pet food according to the second embodiment.

The method for producing a pet food according to the present embodiment includes the coating step of coating the part of the base substance with the coating part-forming composition having a composition different from a composition of the base substance, and the solidifying step of solidifying the coating part-forming composition.

<<Production Example of Base Substance>>

Any base substance can be used as the base substance to be used in the method for producing a pet food according to the present embodiment. In the following, a production method in a case where the base substance is a puffed granule is exemplified.

[Granulating Step]

In a granulating step, a mixture of ingredients is granulated to obtain pet food granules. Known methods can be used as the method of mixing ingredients to obtain a mixture of the ingredients and the method of forming (granulating) the mixture of the ingredients in a granular shape.

For example, a method for producing the puffed granules using an extruder can be suitably used.

As a method for producing puffed granules using an extruder, for example, a method described in “Small Animal Clinical Nutrition 5th Edition” (edited by Michael S. Hand, Craig D. Thatcher, Rebecca L. Remillard, Philip Roudebusg, and Bruce J. Novotny, published by Mark Morris Associates; 2014; p 204 to 215) or the like can be used.

An example of the method for producing the puffed granules using an extruder will be described. First, among the ingredients of the puffed granules, ingredients other than external additives are pulverized as necessary and mixed. The ingredients may be mixed while being pulverized using a grinder or the like. Further, water (which is not included in the ingredient composition) is added thereto as necessary to obtain a mixture of the ingredients.

The obtained mixture of the ingredients is put into the extruder, heated, pressed, and then extruded from an outlet. The outlet is provided with a plate in which a hole having a predetermined shape is formed and a cutter for cutting the mixture of the ingredients extruded from the plate to have a predetermined length (thickness). At the same time as the extrusion of the mixture of the ingredients from the hole in the plate and the formation of the mixture in a predetermined shape by cutting the mixture using a cutter, the mixture of the ingredients is released to atmospheric pressure from the pressurized state so that water vapor in the mixture of the ingredients expands, and the mixture of the ingredients is puffed, thereby obtaining porous granules.

[Drying Step]

The granules to be obtained in the above-described manner are dried as necessary until a predetermined moisture content is obtained to obtain puffed granules (food granules). In a case where dry type food granules are produced, the drying step is indispensable.

For example, the moisture content of granules to be discharged from the extruder is 10% to 20% by mass. In a case where the granules have such a water content, excellent formability is likely to be obtained.

The temperature of granules to be discharged from the extruder depends on the heating temperature in the extruder. For example, the temperature thereof may be 90° C. to 150° C.

As the method of drying the granules discharged from the extruder, a known method can be appropriately used. Examples of the known method include a hot air drying method of drying granules by blowing hot air to the granules; a vacuum drying method; and a method of frying granules in oil. For example, a hot air drying method using a conveyor type hot air dryer is preferable.

The drying conditions (the temperature and the time) may be conditions capable of increasing the temperature of granules to 100° C. or higher to evaporate the moisture in the granules without thermal denaturation of the components of the granules and adjusting the moisture content of the granules to a desired value.

For example, in a case where the granules are dried by a hot air dryer, the temperature of the hot air coming into contact with the granules is preferably in a range of 100° C. to 140° C. and more preferably in a range of 100° C. to 110° C. The drying time is not particularly limited, and the granules are dried for approximately 5 to 20 minutes.

The pet food may be further coated with a coating agent containing crude beef tallow, a seasoning, or a flavoring agent after being dried.

The coating method is not particularly limited, and the pet food can be coated according to a vacuum coating method.

The vacuum coating method is a method of reducing the pressure in a state in which the heated food granules and the coating agent are in contact with each other or adhere to each other and slowly releasing the food granules to the atmosphere. The coating agent may be in a liquid or powder state. By coating the food granules with the coating agent, the palatability (biting property) for a pet can be improved.

<<Production of Coating Part-Forming Composition>>

Any composition can be used as the coating part-forming composition to be used in the method for producing a pet food according to the present embodiment, as long as the component composition of the base substance is different. A production method in a case where the coating part-forming composition is the creamy composition is exemplified below.

First, oil and fat components are put into a cylindrical pot or the like and mixed, and heated to 50° C. to 70° C. (preferably about 65° C.) (oil and fat component mixture). Also, ingredients other than the oil and fat component are mixed (powder ingredient mixture). Next, while adding the powder ingredient mixture to the oil and fat component mixture, the mixture is stirred for about 10 to 15 minutes with a Homo disper or a homogenizer. During stirring, it is preferable to maintain the temperature at 55° C. or higher (preferably about 60° C.). In this manner, a creamy coating part-forming composition can be obtained. After the stirring, the coating part-forming composition may be filtered using a sieve (for example, opening 650 to 800 μm). The coating part-forming composition can be stored in a heat-retaining tank kept at 40° C. to 70° C.

<<Coating Step>>

The coating step is a step of coating a part of the base substance with the coating part-forming composition. The coating step can be performed using, for example, a decorator. For example, the part of the base substance can be coated with the coating part-forming composition by discharging the coating part-forming composition from above to the base substance transported by the conveyor, with a decorator. A nozzle diameter of the decorator may be appropriately adjusted according to the size of the base substance, and examples thereof include approximately φ0.5 to 2 mm (for example, approximately φ0.75 mm). Moving of the nozzle of the decorator is not particularly limited, and the nozzle of the decorator may move to an ellipse direction with respect to an advancing direction of the conveyor, from the viewpoint of coating efficiency. During discharging of the coating part-forming composition, it is preferable that the vicinity of a discharge part of the decorator be kept at 40° C. to 70° C.

The coating part is formed only on an upper surface of the base substance by discharging the coating part-forming composition from above to the base substance. After forming the base substance on the upper surface of the base substance, the base substance is reversed and the coating part-forming composition is discharged to a back surface of the base substance. Accordingly, the coating part can also be formed on the back surface of the base substance.

<<Solidifying Step>>

The solidifying step is a step of solidifying the coating part-forming composition. The coating part-forming composition can be solidified, for example, by cooling. For the cooling, a temperature may be lowered to a solidification temperature of the coating part-forming composition, and is, for example, 30° C. to 40° C. or lower. The coating part-forming composition can be solidified even at room temperature, but in order to shorten the time until the solidification, cooling may be performed by a spot cooler or the like.

In this manner, the pet food according to the first embodiment or the granular pet food according to the second embodiment can be manufactured.

<<Optional Step>>

The production method according to the present embodiment may include an optional step in addition to the coating step and the solidifying step. Examples of the optional step include a connection-breaking step.

The connection-breaking step is a step of breaking a chunk of pet food joined by the coating part-forming composition. The connection-breaking can be performed by applying an impact to the base substance. A method of applying the impact is not particularly limited, and examples thereof include a method of loosening the connection using a ladder chute or the like and a method of applying vibration. The connection-breaking step may be performed after the coating step and before the solidifying step, after the solidifying step, or before and after the solidifying step.

### EXAMPLES

The present invention will be described in more detail with reference to the following examples, but the present invention is not limited to these examples. Hereinafter, “%” indicates “% by mass” unless otherwise noted.

<Palatability Evaluation Method (1)>

The palatability was evaluated by a method of comparing food consumption of the combination of a pet food B and a pet food A. The test was conducted for 2 days using a predetermined number of cats as a monitor.

On the first day, one of the pet foods A and B is fed from the left and the other from the right at the same time with a predetermined feeding amount for one cat. When the cat has completely eaten one or the other or after one hour, the amount of pet food that the cat ate was measured.

From the total weight of the pet food that one cat ate on the first day, the food consumption of the pet food B and the food consumption of the pet food A were calculated as a percentage. The percentages obtained were averaged based on the number of cats monitored to obtain results on Day 1.

On the second day, in the pet foods A and B, contrary to the first day, one was given from the right and the other was given from the left at the same time. One cat was fed with the same amount of feeding as on the first day, and the amount of the pet food consumed by the cat was measured when the cat completely ate one or after one hour.

The result of the second day was obtained by the same calculation method as that of the first day.

Finally, the results of the first day and the second clay were averaged, and the final result, a ratio of the food consumption of pet food A:pet food B “numerical value A:numerical value B” (palatability) was determined. The higher the numerical value of the palatability, the more preferable that the cat as a monitor eats.

<Palatability Evaluation Method (2)>

For users of pet foods for cats, the palatability of pet foods consumed by domestic cats was evaluated for pet foods A and B, and a questionnaire survey was conducted on the palatability. Tests were conducted on a predetermined number of users for 5 days with the pet food A and 5 days with the pet food B, for a total of 10 days.

Groups were divided into a group in which domestic cats evaluated the pet food A first and then the pet food B and a group in which domestic cats evaluated the pet food B first and then the pet food A, a ratio “numerical value A: numerical valve B” of users who evaluated that the palatability of the pet food A was higher: a ratio of users who evaluated that the palatability of the pet food B was higher was obtained.

<Compression Test (Measurement of Breaking Force)>

A breaking force when the granular pet food was compressed at a constant compression speed was measured under the following conditions, using a compression tester (texture analyzer, model number: EZ-SX, manufactured by Shimadzu Corporation).

Plunger: cylindrical plunger with a diameter of 15 mm and a thickness of 5 mm, platform: saucer deeply dug in an asterisk shape (an inner diameter about 33 mm×a depth about 4 mm), compression speed: 60 mm/min, lowest point of the plunger: 4 mm (compression distance), and a measurement temperature: 25° C.

That is, one granular pet food to be measured was placed on the saucer, and a test force is measured while vertically pressing the plunger from directly above the granule at a constant speed. A peak value (maximum value) of the test force is read as the value of breaking force value. The measurement is repeated for 10 granule to obtain an average value. In a case where the granule is broken during the measurement, the measurement of the granule is finished at that point. For the pet foods each having a coating part with cream, the area having the coating part is measured.

The breaking force (unit: kgw) measured by the compression tester is multiplied by 9.8 so that a unit thereof is converted to Newton (N).

### Production Example 1

(Production of Base Substance)

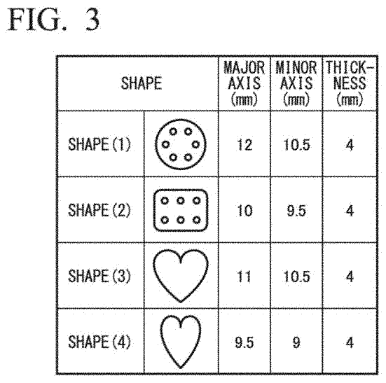

The ingredients of the base substance were mixed in the formulation shown in Table 1. The obtained mixture of the ingredients was put into an extruder and heat-treated at approximately 115° C. for approximately 2 minutes while kneading to pregelatinize starch components, and extruded and granulated into a granular shape at an outlet of the extruder and puffed at the same time. At the outlet of the extruder, kneaded matter was extruded into a column shape from the hole having the shape shown in FIG. 3, and the columnar matter was cut with a cutter so as to have a thickness of 4 mm to obtain granular matter.

The obtained granular matter was dried at approximately 100° C. for 5 to 20 minutes using a dryer, and then coated with an external additive (1.5% oil coating) to obtain a base substance which is a dry type puffed granule.

TABLE 1

| Ingredient | Mass (%) |
|---|---|
| Cereals | 39.4% |
| Meats | 39.2% |
| Seafoods | 3.8% |
| Yeasts | 3.2% |
| Vitamins, minerals, and amino | 3.6% |
| acids | |
| Animal oil and fat | 10.8% |

(Decoration with Cream)

A cream ingredient was mixed in the formulation shown in Table 2. Vegetable oil and fat and hardened oil and fat were put into a cylindrical pot and warmed to 65° C. (Mixture 1). Soy protein and dextrin were mixed (Mixture 2).

While adding the mixture 1 and the mixture 2, the mixture was stirred with a Homo disper (Auto Mixer Model 20, manufactured by Primix Corporation) for 10 to 15 minutes. The obtained mixture was passed through a sieve (opening 710 μm) to obtain a cream. The cream was stored in a storage tank kept at 40° C. to 70° C.

TABLE 2

| Ingredients | Mass (%) |
|---|---|
| Vegetable oil and fat | 32.6% |
| Hardened oil and fat | 18.6% |
| Soy protein | 37.2% |
| Dextrin | 11.6% |

The cream was put into a decorator, the decorator was reciprocated in an elliptical direction, and the cream was sprinkled on the base substance from above. The decoration was performed such that a ratio of total mass of the entire base substances to total mass of the cream used for decoration (total mass of base substances/total mass of cream) was 93/7. After the decoration, a pet food P1 was obtained by cooling.

### Production Example 2

A pet food was produced by the same production method as that of Production Example 1 to obtain a pet food P2, except that the ratio of the total mass of the entire base substances to the total mass of the cream used for decoration (total mass of base substances/total mass of cream) was 90/10.

[Production of Pet Food of Comparative Examples]

### Comparative Example 1

A base substance was produced by the method described in Production Example 1 above, and was used as a pet food Z1 of a comparative example without decoration with cream.

### Comparative Example 2

A base substance was produced by the method described in Production Example 1 above, and 100% of the surface of the base substance was coated with the cream described in Production Example 1. The coated base substance was used as a pet food Z2 of the comparative example.

<Color Measurement>

Using a colormetric color difference system ZE6000 (manufactured by Nippon Denshoku Industries Co., Ltd.), colors of the base substance and the cream were measured.

The base substance was uniformly pulverized using a Millser (manufactured by Iwatani Corporation) to obtain a measurement sample.

The cream was heated at 70° C., dissolved, poured into a measurement container, and allowed to stand at room temperature for 1 hour to solidify to obtain a measurement sample.

A measurement sample was put in the amount of about 80% into a measurement container with a capacity of 10 mL, and each coordinate value in the CIELAB color space was measured at three points according to the manual included with the device.

Results are shown in Table 3. Table 3 shows an average value of measurements at three locations.

In Table 3, Chroma (C*) was obtained by C*={(a*)²+(b*)²}^{1/2}.

TABLE 3

| | | ′(+) Red | ′(+) Yellow | |
|---|---|---|---|---|
| | Lightness | (−) Green | (−) Blue | Chroma |
| | (L*) | (a*) | (b*) | (C*) |
| Base | 49.50 | 11.12 | 35.57 | 37.30 |
| substance | | | | |
| Cream | 58.78 | 8.72 | 32.36 | 33.52 |

In addition, a difference in the chroma of the cream with respect to the base substance was determined by the following calculation formula. The results are shown in Table 4.

ΔL*: Cream (L*)−Base substance (L*)

Δa*: Cream (a*)−Base substance (a*)

Δb*: Cream (b*)−Base substance (b*)

ΔE*: {(ΔL*)²+(Δa*)²+(Δb*)²}^{1/2}

ΔC*: Cream (C*)−Base substance (C*)

TABLE 4

| | ′(+) Red | ′(+) Yellow | Color | |
|---|---|---|---|---|
| Lightness | (−) green | (−) Blue | difference | Chroma |
| (ΔL*) | (Δa*) | (Δb*) | (ΔE*) | (ΔC*) |
| 9.28 | −2.50 | −3.21 | 10.13 | −3.78 |

From the results shown in Table 4, it was confirmed that the cream and the base substance had different colors. In the examples above, ΔC was a negative value, and the cream was visually recognized as a paler color than the base substance. ΔC may have a positive value, and in this case, the cream was visually recognized as a lighter color than the base substance.

<Measurement (1) of Area Proportion of Coating Part>

The cream-coated area proportion was measured by image analysis using a visual analyzer, consigning to the Japan Food Analysis Center.

About 50 g of pet food granules was scattered on a measurement area on the plane, and color composition analysis data of the surface portion was acquired. From the data obtained by analyzing the composition of each color with respect to the entirety, a color having a color difference (ΔE*) with respect to the central color of the cream of 13.0 or less was analyzed as the color of the cream, and the coating area proportion of the cream was obtained. The results are shown in Table 5.

TABLE 5

| | Total mass of base substance/ | Cream-coated area |
|---|---|---|
| | Total mass of cream | proportion (%) |
| Pet food P1 | 93/7 | 8.06 |
| Pet food P2 | 90/10 | 9.65 |

<Measurement (2) of Area Proportion of Coating Part>

The pet food is observed and photographed with an optical microscope (VHX-900F (manufactured by KEYENCE)), and a cream-coated area proportion was measured.

Specifically, the pet food granule having a cream coating part was observed by an optical microscope, and an image of a surface having the cream was acquired. Based on the image, a surface area of the entire pet food granules and a cream-coated area were measured, and the cream-coated area proportion to the entire pet food granules was calculated as a percentage. The results are listed in Table 6. The cream-coated area proportion shown in Table 6 is an average value of three pet food granules.

TABLE 6

| | Total mass of base substance/ | Cream-coated area |
|---|---|---|
| | Total mass of cream | proportion (%) |
| Pet food P1 | 93/7 | 16.7 |
| Pet food P2 | 90/10 | 23.8* |

*Calculated value based on measurement value of pet food P1

<Palatability Evaluation>

### Test Example 1

For the pet food P2 produced in Production Example 2, the palatability (biting) was evaluated by the palatability evaluation method (1).

The pet food P2 was used as the pet food A, and the pet food Z1 of Comparative Example 1 was used as the pet food B. Although the cat species as the monitor is not specified, each adult cat had a feeding amount of 40 g and the number of cats was 20. The results are shown in Table 7.

### Test Example 2

The pet food Z1 of Comparative Example 1 was used as the pet food A, and the pet food Z2 of Comparative Example 2 was used as the pet food B. Although the cat species as the monitor is not specified, each adult cat had a feeding amount of 40 g and the number of cats was 10. The results are shown in Table 7.

### Test Example 3

For the pet food P1 produced in Production Example 1, the palatability (biting) was evaluated by the palatability evaluation method (2).

The pet food P1 was used as the pet food A, and a commercial product A [granular pet food including pet food granules obtained by filling a cereal-based outer shell with cream; Sheba (registered trademark), Duo (registered trademark)] was used as the pet food B. The number of users was 70. The results are shown in Table 7.

TABLE 7

| | | |
|---|---|---|
| Test Example | Pet food P2:Pet food Z1 | 57:43 |
| 1 | | |
| Test Example | Pet food Z1:Pet food Z2 | 84:16 |
| 2 | | |
| Test Example | Pet food P1:Commercial product A | 58:42 |
| 3 | | |

As shown in the results of Table 7, the pet food P2 had improved palatability as compared to the pet food Z1 including only the base substance (Test Example 1). Since the pet food Z1 had the more improved palatability as compared to the pet food Z2 in which the base substance was coated 100% with cream (Test Example 2), the pet food P2 was estimated to have a higher palatability than that of the pet food Z2.

In addition, the pet food P1 had improved palatability as compared to a commercial product in which a cereal-based outer shell was filled with cream (Test Example 3).

<Evaluation of Hardness>

For the pet food P1 produced in Production Example 1, the pet food Z1 in Comparative Example 1, the commercial product A [granular pet food including pet food granules obtained by filling a cereal-based outer shell with cream; Sheba (registered trademark), Duo (registered trademark)], and a commercial product B [granular pet food including cereal-based puffed granules], breaking force was measured by the compression test (measurement of the breaking force) to evaluate the hardness. The results are listed in Table 8.

TABLE 8

| | Average | Maximum | Minimum |
|---|---|---|---|
| | value (N) | value (N) | value (N) |
| Pet food P1 (N = 80) | 55.7 | 88.4 | 28.2 |
| Pet food Z1 (N = 80) | 48.8 | 68.8 | 33.1 |
| Commercial product A | 20.4 | 31.1 | 15.6 |
| (N = 10) | | | |
| Commercial product B | 71.7 | 99.8 | 53.9 |
| (N = 10) | | | |

As shown in the results of Table 8, it was confirmed that the pet food P1 had a wider hardness range from the minimum value to the maximum value and gave various textures as compared to the pet food Z2 and the commercial product. In addition, the pet food P1 had a texture harder than that of the commercial product A and had a texture less hard than that of the commercial product B, and it was confirmed that the pet food P1 had improved hardness to be easy to eat.

In the pet food P1 produced in Production Example 1, the pet food Z1 of Comparative Example 1, the commercial product A, and the commercial product B, a breaking force curve (horizontal axis: plunger displacement amount (mm), and vertical axis: test force (N)) was obtained by the compression test (measurement of the breaking force). In the obtained breaking force curve, an inclination (change amount of breaking force (0 to 5 N)/plunger displacement amount (mm)) of a portion where the test force was from 0 N to 5 N was determined. The results are listed in Table 9.

TABLE 9

| | Average | Maximum | Minimum |
|---|---|---|---|
| | value | value | value |
| | (N/mm) | (N/mm) | (N/mm) |
| Pet food P1 (N = 80) | 14.3 | 53.8 | 1.5 |
| Pet food Z1 (N = 80) | 28.1 | 66.7 | 2.8 |
| Commercial product A | 16.2 | 20.7 | 7.6 |
| (N = 10) | | | |
| Commercial product B | 16.2 | 25.0 | 6.2 |
| (N = 10) | | | |

As shown in the results of Table 9, it was shown that the pet food P1 tended to have a smaller inclination, as compared to the pet food Z1. This result shows that the cream-coating part of the pet food P1 had a softer texture than that of the base substance. In addition, it was confirmed that the pet food P1 had a wider range from the minimum value to the maximum value than that of the commercial product A and the commercial product B and gave various textures from the beginning of chewing.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A pet food, comprising:
a base substance; and
a coating part that coats a part of the base substance;
wherein the part of the base substance is exposed, and
a component composition of the base substance and a component composition of the coating part are different from each other.

2. The pet food according to claim 1,
wherein a color of the base substance and a color of the coating part are different from each other.

3. The pet food according to claim 2,
wherein the pet food satisfies at least one condition selected from the group consisting of the following (a) to (d) in a CILAB color space,
(a) ΔL* (L* of coating part−L* of base substance) is 5.0 or more,
(b) ΔE* (color difference between coating part and base substance) is 5.0 or more,
(c) ΔC* (C* of coating part−C* of base substance) is −7.5 to −1.0, and
(d) ΔC* (C* of coating part−C* of base substance) is 1.0 to 7.5.

4. The pet food according to claim 1,
wherein a taste of the base substance and a taste of the coating part are different from each other.

5. The pet food according to claim 1,
wherein a breaking force of the base substance and a breaking force of the coating part are different from each other.

6. The pet food according to claim 5,
wherein the breaking force of the coating part is weaker than the breaking force of the base sub stance.

7. The pet food according to claim 1,
wherein the base substance has at least one recessed part.

8. The pet food according to claim 1,
wherein the coating part contains oil and fat and a powder ingredient.

9. The pet food according to claim 1,
wherein an area proportion of the coating part to a surface area of an entirety of the pet food is 5% to 50%.

10. The pet food according to claim 1, comprising:
a surface having the coating part; and
a surface formed by only an exposed portion where the base substance is exposed.

11. The pet food according to claim 1,
wherein a height from a surface of the base substance to a topmost part of the coating part is 0.1 to 2 mm.

12. The pet food according to claim 1,
wherein the base substance has a granular shape.

13. The pet food according to claim 12,
wherein the base substance is a puffed granule.

14. A granular pet food, comprising: a plurality of pet food granules,
wherein the plurality of pet food granules includes a plurality of the pet foods according to claim 12, and
an area proportion of the coating parts to a surface area of an entirety of the plurality of pet food granules is 5% to 50%.

15. A method for producing a pet food including a base substance, and
a coating part that coats a part of the base substance, in which
the part of the base substance is exposed, and
a component composition of the base substance and a component composition of the coating part are different from each other,
the method comprising:
a coating step of coating the part of the base substance with a coating part-forming composition having a composition different from a composition of the base substance; and
a solidifying step of solidifying the coating part-forming composition.
